(19) United States
(12) Patent Application Publication
(10) Pub. No.: US 2010/0025141 A1
(43) Pub. Date: Feb. 4, 2010

(54) Electro-Pneumatic Brake Control Device

(76) Inventors: Uwe Bensch, Hannover (DE); Henning Förster, Nordstemmen (DE); Bernd-Joachim Kiel, Wunstorf (DE); Wilfried Menze, Springe (DE); Hartmut Rosendahl, Hannover (DE); Otmar Struwe, Hannover (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/083,660

(22) PCT Filed: Oct. 20, 2006
(86) PCT No.: PCT/EP2006/010151

§ 371 Date: Mar. 13, 2009

(30) Foreign Application Priority Data
Dec. 9, 2005 (DE) 10 2005 058 799.2

(51) Int. Cl. B60R 21/00; B60T 13/68

(52) U.S. Cl. 180/271; 303/15

(57) ABSTRACT

An electro-pneumatic brake control device is provided for controlling a parking brake of a vehicle having a service brake and a parking brake, the service brake having a brake pedal and pneumatically actuatable brake cylinders operatively connected to the brake pedal for actuating wheel brakes. At least one brake cylinder is a spring brake cylinder with a spring store part for actuating the parking brake. In the event of a failure of the electrical energy supply, the spring store part of the spring brake cylinder is permanently vented by actuating the brake pedal in order to activate the parking brake.

### BACKGROUND OF THE INVENTION

The present invention relates generally to an improved electro-pneumatic brake control device for controlling the parking brake of a vehicle.

EP 1 571 061 A1 describes a brake control device and a brake system of the general type under consideration. Such systems provide a service brake, which can be actuated by means of a brake pedal, and a parking brake (often also referred to as a handbrake), which can be actuated by means of an electric signal transducer.

The failure of the electric power supply can be a problematic event in such electrically controlled brake systems as electric components, such as electric control systems and electrically actuated solenoid valves, can no longer be actuated. Furthermore, electric signal transducers for the parking brake can also fail as a result of such power failures. DE 199 53 805 C1 and EP 1 571 061 A1 propose that emergency braking may be initiated automatically whenever the electric power supply fails by venting a spring actuator that acts on the parking brake. Automatic emergency braking can be disadvantageous, however, since under certain circumstances, the vehicle may then come to a stop at an unsuitable place from which it cannot be removed without outside help. Furthermore, such automatic emergency braking operations usually involve maximum braking action, which may also present a hazard by reason of traffic following the braking vehicle.

EP 1 571 061 A1 proposes a brake system where, in the event of failure of the electric power supply, the vehicle may be braked gradually by actuating the brake pedal under pneumatic control of the spring store parts of the spring brake cylinders. However, this solution has the disadvantage that the spring brake cylinders are repressurized as soon as the brake pedal is no longer being actuated, with the result that the parking brake is released once again. Thus, with this known system, the vehicle cannot be safely parked.

### SUMMARY OF THE INVENTION

Generally speaking, in accordance with the present invention, embodiments of an improved electro-pneumatic brake control device for a vehicle parking brake control system are provided that overcome disadvantages associated with conventional devices.

According to the present invention, for a vehicle parking brake control system comprising wheel brakes, a service brake responsive to a brake pedal and spring brake cylinders for actuating the wheel brakes, a parking brake, and an electric power supply, an electro-pneumatic brake control device is provided that enables a vehicle operator to effect permanent venting of the spring store parts of the spring brake cylinders during electric power supply failure by actuating the service brake pedal, whereby the parking brake is applied. Since venting takes place permanently, the spring store parts of the spring brake cylinders also cannot be accidentally repressurized and, thus, lead to an undesirable release of the parking brake. The vehicle operator can, therefore, brake the vehicle selectively and park it safely by actuating the brake pedal. The parking brake is finally applied by means of the spring actuator, and, thus, the vehicle is brought into a parked condition and the operator can safely exit the vehicle. The operator also has the option, for example, of driving into a parking place or onto a highway shoulder and then setting the parking brake in parked condition by actuating the brake pedal.

It is thus an object of the present invention to provide an electro-pneumatic brake control device for a vehicle parking brake control system that enables the vehicle to be safely parked even in the event of total failure of the electric power supply.

Still other objects and advantages of the present invention will in part be obvious and will in part be apparent from the specification.

The present invention accordingly comprises the features of construction, combination of elements, and arrangements of parts which will be exemplified in the constructions hereinafter set forth, and the scope of the invention will be indicated in the claims.

### BRIEF DESCRIPTION OF THE DRAWINGS

The present invention will be described in more detail hereinafter on the basis of the accompanying drawings, wherein:

FIG. 1 is a schematic diagram of a compressed air brake system having an electro-pneumatic brake control device for controlling a parking brake; and

FIGS. 2-4 are schematic diagrams depicting various exemplary embodiments of an electro-pneumatic brake control device for controlling a parking brake in accordance with the present invention.

### DETAILED DESCRIPTION OF THE PREFERRED EMBODIMENT

In accordance with the present invention, the control device for a vehicle parking brake is provided with a compressed air supply line which can be placed in communication with a compressed air reservoir tank for actuating the spring store parts of the spring brake cylinders. An air flow boosting device, such as a relay valve, has an inlet which can be placed in communication with the compressed air supply line and an outlet which can be placed in communication with a compressed air line to the spring store parts of the spring brake cylinders. A pneumatic control input supplies control pressure for controlling the pressure at the outlet of the air flow boosting valve device. An electrically actuated bistable valve is included and has an inlet, which can be placed in communication with the compressed air supply line, and an outlet, which can be placed in communication with the control input of the relay valve. In parked position, the outlet of the bistable valve is in communication with a vent, and in driving position its outlet is in communication with its inlet. The bistable valve is electrically connected to an electric control unit which controls the bistable valve.

By means of the air flow boosting valve device, the pressure on the spring store parts of the spring brake cylinders can be controlled in order to release the parking brake or to apply the parking brake in a controlled manner. Control of the air flow boosting valve device is effected by a control pressure, which, in a simple case, is passed by means of the electrically actuated bistable valve to the control input of the air flow boosting device. The supplied air pressure is obtained from a reservoir tank of the compressed air supply for the parking brake. The bistable valve has a driving position, in which the pressure of the reservoir tank is applied to the control input of the air flow boosting valve device. In a parked position, on the other hand, the control input is in communication with a vent outlet on the bistable valve, and, so, the control pressure drops, as does the pressure at the outlet of the air flow boosting valve device and also in the spring store parts of the spring brake cylinders. As a result, the parking brake is applied. The bistable valve can be electrically actuated, and, so, the bistable valve can be brought into the respective position (parked position or driving position) by means of an electric signal transducer via the electric control unit. By virtue of the design of this valve as a bistable valve, the condition or position of this valve does not change even during a power failure. This is advantageous inasmuch as the situation is prevented in which, in the event of a power failure, the parking brake would be automatically applied by venting of the spring store parts of the spring brake cylinders, meaning that automatic emergency braking would be initiated.

Furthermore, according to an embodiment of the present invention, an electrically actuated holding valve is provided on the brake control device. The holding valve is in communication with the electric control unit and is connected between the control input of the air flow boosting valve device and the outlet of the bistable valve. In a deenergized condition of the holding valve, its inlet is in communication with the bistable valve's outlet and, in an energized condition, its inlet is shut off from the bistable valve's outlet. By means of this holding valve, the pressure at the control input of the air flow boosting valve device can be metered. As a result, controlled braking of the vehicle, even with the parking brake, is possible. In fact, by virtue of the holding valve, it is possible in principle to exert any desired brake force with the parking brake.

In a preferred embodiment of the present invention, a check valve is provided in the compressed air supply line between the inlet of the air flow boosting valve device and a branch in the compressed air supply line to the bistable valve. The check valve is open or conveying pressure in the direction from this branch to the air flow boosting valve device, but shuts off in the opposite direction, and this branch can be placed directly in communication with the compressed air reservoir tank, especially without interposing a further check valve.

In contrast to this preferred embodiment, a check valve is conventionally installed upstream from the control device of the parking brake to ensure that pressure fluctuations, such as can occur, for example, during braking operations using an antilock brake system, do not lead to application of the parking brake. In principle, the compressed air reservoir tank of the parking brake circuit is indeed a separate structure from the compressed air reservoir tank of the brake circuits of the front axle and of the rear axle of the vehicle. However, these reservoir tanks communicate with one another, such that a pressure drop in one of the reservoir tanks also leads to a pressure drop in another, especially the compressed air reservoir tank of the parking brake circuit system. This interaction between the reservoir tanks can lead, for example in the case of braking operations involving the antilock brake system, to a considerable pressure drop in the reservoir tanks of the front axle and of the rear axle, ultimately also leading to a pressure drop in the reservoir tank of the parking brake circuit. By virtue of the check valve that is normally installed upstream from the control device of the parking brake, application of the parking brake can therefore be prevented. In this conventional arrangement, however, the check valve has the disadvantage that selective lowering of the pressure in the parking brake circuit is prevented by repeated actuation of the service brake pedal. When a check valve is disposed upstream from the control device of the parking brake, lowering of the pressure at the control input of the air flow boosting valve device is prevented specifically during a power failure, and so the parking brake also cannot be applied. For construction of the brake circuits described herein, especially on the basis of the bistable valve, this means that, in the event of failure of the electric power supply, and following repeated actuation of the service brake, on the one hand the service brake pressure is completely consumed, and on the other hand the spring store parts of the spring brake cylinders can no longer be vented and therefore no longer actuated. Thus, the vehicle can no longer be braked at all.

Returning to the discussion of the preferred embodiment of the present invention, concerning placement of the check valve discussed above, braking of the vehicle remains possible by virtue of the preferred relocation of the check valve between the inlet of the air flow boosting valve device and the branch in the compressed air line to the bistable valve. Because of the installation of the check valve directly upstream from the inlet of the air flow boosting valve device, the control pressure of the air flow boosting valve device is tapped upstream from the check valve. The control pressure of the air flow boosting device can therefore be lowered together with the pressure in the reservoir tank of the parking brake circuit, which pressure drops with the pressure or pressures in the reservoir tanks of the brake circuits of the front axle and of the rear axle in response to repeated actuation of the brake pedal.

During a power failure the control input of the air flow boosting valve device is directly in communication with the reservoir tank of the parking brake circuit. Thereby, the pressure in the control chamber of the air flow boosting valve device is ultimately lowered during repeated actuation of the service brake, so that the spring store parts of the spring brake cylinders are vented and the spring actuators of the parking brake can hold the vehicle. Even in the event of a complete failure of the electric power supply, therefore, the vehicle can be safely parked by means of actuation of the brake pedal.

The preferred embodiment has the particular advantage that, in the event of a failure of the power supply, the spring actuator of the parking brake can be applied slowly by repeated actuation of the brake pedal and the associated pressure drop in the service brake circuits and the parking brake circuit. As a result, abrupt braking can be prevented.

In a further embodiment of the present invention, a pressure sensor connected to the electric control unit is provided in the compressed air supply line at a position—considered in the direction from the pressurized fluid reservoir tank of the parking brake to the air flow boosting valve device—upstream from the check valve. This pressure sensor prevents undesired application of the parking brake in normal operation by detecting pressure fluctuations that may occur (one example of such fluctuation is as a result of braking operations involving the antilock brake system). If the pressure—mainly passed to the control input of the air flow boosting valve device—measured by the pressure system drops below a critical value, the holding valve is energized, so that the pressure line in which the holding valve is disposed is interrupted and, thus, the control pressure in the air flow boosting valve device is confined. This confinement of the control pressure in the air flow boosting valve device ensures that the spring store parts of the spring brake cylinders are not vented. Thus, because of actuation of the holding valve during pressure drops below a critical value, undesired application of the parking brake can be reliably prevented.

In another embodiment of the present invention, the brake control device is provided with a valve device that is connected between the inlet of the bistable valve and the compressed air supply line and has an input for a reservoir pressure of the service brake, an inlet in communication with the compressed air supply line, an outlet in communication with the inlet of the bistable valve, and a vent outlet. This valve device can assume at least two conditions, namely, a first condition, which is established at a reservoir pressure of the service brake higher than a predetermined threshold value and in which the inlet of the valve device is in communication with the valve device's outlet, and a second condition, which is established at a reservoir pressure of the service brake lower than a predetermined threshold value and in which the outlet of this valve device is in communication with the vent outlet. This embodiment has the advantage that the parking brake is applied when the spring store parts of the spring brake cylinders are suddenly vented beginning at a certain threshold pressure due to repeated actuation of the brake pedal of the service brake and the associated pressure drop in the reservoir tanks of the service brake and the reservoir tank of the parking brake.

In a further embodiment, the valve device is provided with an input for the pressure in the compressed air supply line, wherein the threshold value is determined by the pressure in the compressed air supply line plus a pressure exerted by a spring store part. The valve device is therefore provided with two inputs, at which the reservoir pressure of the service brake is present on the one hand and the reservoir pressure of the parking brake is present on the other hand, so that the two pressures can be compared with one another. If the service brake pressure is below a certain value, which is determined additionally, but not exclusively, by the reservoir pressure of the parking brake circuit, venting takes place via the bistable valve, which is in driving position and, thus, is open, and via the holding valve—also open—of the control input of the air flow boosting valve device, with the result that the spring store parts of the spring brake cylinders are also vented. This leads to application of the parking brake.

In yet another embodiment, the brake control device is provided with a valve arrangement, which is connected upstream from the control input of the air flow boosting valve device and by means of which the pressure present at the control input can be vented. This valve arrangement can be pressurized on the input side with the pressure of a pneumatic brake circuit provided as a redundancy, or in other words with the redundancy pressure. The valve arrangement is inactive in normal operation, and so the compressed air line is open from the bistable valve or holding valve to the air flow boosting valve device. In the case of failure of the electric power supply, however, the valve arrangement is activated, in which case the redundancy pressure then acts on the valve arrangement in such a way that the control input of the air flow boosting valve device is permanently vented. This embodiment takes advantage of the redundancy pressure to ensure that the control input of the air flow boosting valve device and thus the spring actuated brakes are permanently vented.

Advantageously, the valve arrangement vents the control input of the air flow boosting valve device when the redundancy pressure has exceeded a predetermined threshold pressure for a predetermined time period. As a result, it is ensured that the spring actuated brakes are applied not accidentally, but only when the vehicle operator has actually exerted at least a minimum pressure on the brake pedal for a relatively long time period. In the event of a power failure, and in response to passage of the redundancy pressure through to a pneumatic logic unit, the brake control device of the parking brake therefore vents the control input of the air flow boosting valve device and, thus, the control chamber of the air flow boosting valve device and, consequently, the spring store parts of the spring brake cylinders, whenever the redundancy pressure exceeds a definite pressure value for a definite time period.

A vehicle compressed air brake system will now be discussed in general terms, in order to set the stage for a detailed discussion of the inventive electro-pneumatic device for controlling a parking brake integrated into such a compressed air brake system, with reference to the drawings, where like components are represented by like reference numbers.

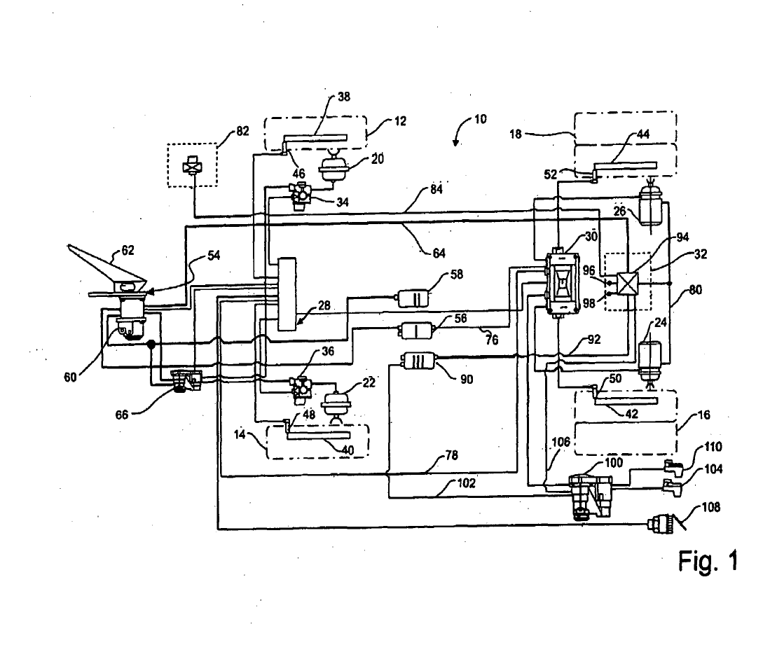

FIG. 1 schematically shows a compressed air brake system 10 for a vehicle having four wheels 12, 14, 16, 18. Brake system 10 is electrically controlled, meaning that the injection of brake pressure to brake cylinders 20, 22, 24, 26 of wheels 12, 14, 16, 18 is controlled by electric and electronic control elements. Brake cylinders 20, 22 of front wheels 12, 14 are controlled by a front axle brake control module 28, and brake cylinders 24, 26 of rear wheels 16, 18 are controlled by a rear axle brake control module 30. Brake cylinders 24, 26 of rear wheels 16, 18 are designed as combined service and spring brake cylinders, wherein the spring store parts are controlled by an electro-pneumatic brake control device for controlling the parking brake, namely a parking brake module 32.

Electromagnetically actuated valves for influencing the brake pressure are connected upstream from each brake cylinder 20, 22, 24, 26. For front wheels 12, 14, valves 34, 36 are used for this purpose. For rear wheels 16, 18, the respective valves are integrated in rear axle brake control module 30.

Sensors for determining the speed of revolution of the respective wheels are mounted on each wheel 12, 14, 16, 18. Each of the speed sensors is provided with a magnet wheel 38, 40, 42, 44 connected to rotate with the respective wheel 12, 14, 16, 18 and coupled electromagnetically with an inductively operating wheel sensor 46, 48, 50, 52.

Brake system 10 is further provided with a brake force transducer 54, which senses the braking intent of the vehicle operator. Brake force transducer 54 comprises an electric and a pneumatic part. The pneumatic part is supplied with compressed air by a first compressed air reservoir tank 56 and a second compressed air reservoir tank 58. These compressed air reservoir tanks 56, 58 are used to supply compressed air to brake cylinders 20, 22 of front wheels 12, 14 or brake cylinders 24, 26 of rear wheels 16, 18, respectively. The pneumatic part of brake force transducer 54 is provided with a two circuit brake valve 60, which is mechanically connected to a brake pedal 62 and can be actuated by means of brake pedal 62. During actuation of brake pedal 62, a pressure signal is supplied from brake valve 60 via a compressed air line 64 to the parking brake module 32. A further second pressure signal decoupled from this first pressure signal is supplied to a front axle valve device 66.

Front axle valve device 66 is provided with a front axle redundancy valve (not separately illustrated) and a pressure regulating valve device (not separately illustrated), such as a proportional relay valve, which converts an electric signal from front axle brake control module 28 to a pneumatic brake pressure.

Via a compressed air line, front axle valve device 66 is in communication with second compressed air reservoir tank 58. It is also connected via an electric line to front axle brake control module 28. In normal operation, a pressure for brake cylinders 20, 22 is regulated by means of an electric signal supplied via the electric line. In what is known as a redundancy case—such as a failure of the electric power supply for the electric controller, or a failure of the entire electric controller of the brake system or failure of individual control modules of the brake system—a changeover takes place to the pressure signal of brake force transducer 54. Compressed air can be supplied to valves 34, 36 by means of front axle valve device 66.

Via a pneumatic line 76, rear axle brake control module 30 is in communication with first compressed air reservoir tank 56. Rear axle brake control module 30 is also provided with a data interface, which is connected via electric line 78 to a further data interface of front axle brake control module 28. Modules 28, 30 exchange data via these data interfaces. For example, rear axle brake control module 30 receives from front axle brake control module 28 the vehicle operator's braking intent sensed by means of brake force transducer 54 and controls the brake pressure in brake cylinders 24, 26 of rear wheels 16, 18 via valves disposed in rear axle brake control module 30. Rear axle brake control module 30 draws the compressed air necessary for this purpose from first compressed air reservoir tank 56.

Brake cylinders 24, 26 are designed as combination brake cylinders, namely, as combination spring actuator/diaphragm cylinders. In addition to the function of diaphragm cylinders, which corresponds approximately to the function of brake cylinders 20, 22, brake cylinders 24, 26 additionally have a spring actuator function. Brake cylinders 24, 26 each include a diaphragm part, which is in communication pneumatically with the service brake system of the rear axle and can be pressurized with the actual brake pressure, and a spring store part, which is pneumatically separated from the diaphragm part and can be pressurized with compressed air via separate compressed air lines. The spring store parts form part of the parking brake (which is frequently also referred to as a handbrake). The spring store parts include the spring actuator function, which preloads a spring actuator upon admission of compressed air to the spring store part and, thus, prevents or diminishes braking action of the spring actuator function, whereas the actuator springs relax upon venting of the spring store parts and, thus, in connection with the spring actuator function, exert a braking action on the brake associated with the respective brake cylinder. In the present context, brake cylinders of this type are referred to as spring brake cylinders.

By means of these spring brake cylinders, a parking brake function is achieved that also permits the vehicle to be braked or immobilized even in the absence of compressed air. The parking brake function takes place when the respective spring store parts of spring brake cylinders 24, 26 are vented below a minimum pressure value. Via compressed air lines 80, the spring store parts of brake cylinders 24, 26 are pneumatically in communication with parking brake module 32, which permits pressure control by way of electronic control means.

A manually actuated parking brake signal transducer 82 is connected via a multi conductor electric line 84 to parking brake module 32. The electric devices in the vehicle are supplied with electric power by an electric power supply device, not illustrated, such as a vehicle battery, via appropriate electrical lines.

Via a compressed air line 92, third compressed air reservoir tank 90 is in communication with parking brake module 32. Compressed air reservoir tank 90 provides the compressed air supply for the parking brake circuit (and a coupled trailer).

Parking brake module 32 is further equipped with an input port 94 for the pressure signal supplied via compressed air line 64. Parking brake module 32 also has ports 96, 98 for the electric power supply and a data interface. Port 96 for the data interface is used for connection to a data bus system provided in the vehicle and also referred to as the vehicle bus. The vehicle bus is used for data exchange between various units provided in the vehicle and an electronic controller, such as modules 28, 30, which for this purpose are also connected via respective data interface ports to the vehicle bus.

The vehicle described above is suitable for coupling to a trailer and is also referred to as a tractor vehicle. The unit comprising the tractor vehicle and trailer is referred to as a vehicle train.

Brake system 10 is further provided with a trailer control valve 100, which is used for brake pressure control of a coupled trailer. For its compressed air supply, trailer control valve 100 is in communication via compressed air line 102 with third compressed air reservoir tank 90. In response to electric and pneumatic control signals, trailer control valve 100 delivers the compressed air drawn from compressed air reservoir tank 90 incrementally via compressed air port 104 to the brake system of a coupled trailer. For control of this pressure delivery, trailer control valve 100 has an electric signal input, which is connected to rear axle brake control module 30 and via which trailer control valve 100 receives an electric signal that reflects the braking intent of the operator. Alternatively, the electric signal input can also be connected to front axle brake control module 28. A pressure control input for receiving pneumatic control signals is also provided. Via compressed air line 106, the pressure control input is in communication with parking brake module 32.

An electric plug connection 108 is used for supplying power and transferring data signals to the trailer. A compressed air supply port 110 is also provided for supplying the trailer with reservoir pressure.

Brake system 10 is further provided with a compressed air supply system (not illustrated), such as a compressor driven by the vehicle engine and used to fill compressed air reservoir tanks 56, 58, 90 with compressed air.

The brake system described above corresponds largely to the brake system described in EP 1 571 061 A1. The functioning principles of the above described brake system bear on an understanding of the parking brake control modules according to exemplary embodiments of the present invention, where the inventive modules are integrated in the brake system as described in more detail below.

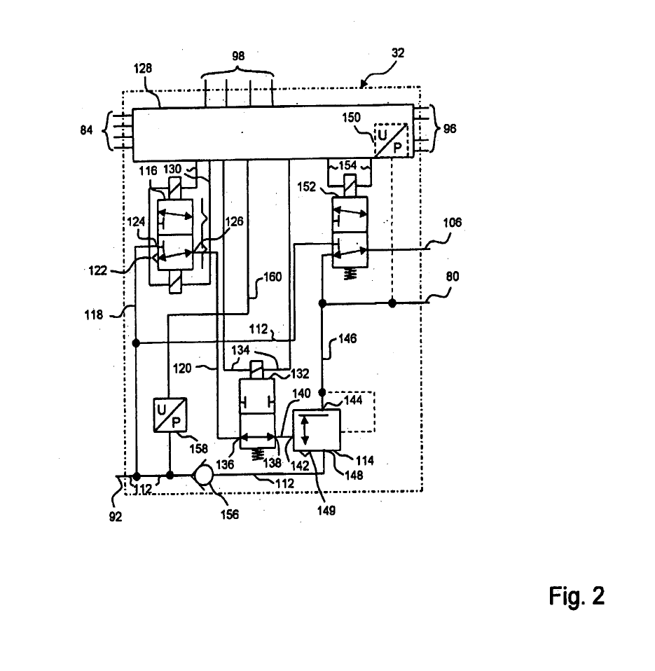

FIG. 2 schematically shows a parking brake control module 32 according to one exemplary embodiment of the present invention. Compressed air line 92 is in communication with a compressed air supply line 112, by means of which compressed air is supplied to an air flow boosting valve device designed as relay valve 114. Thus, parking brake control module 32 is supplied with air from third compressed air reservoir tank 90. A bistable valve 116 is in communication with compressed air supply line 112 via compressed air line 118. Bistable valve 116 is designed as an electromagnetically actuated valve, preferably as a 3/2 way valve. It has a first switched position, also known as parked or vented position, as illustrated in FIG. 2. In this position, an outlet 126 in communication on the output side with a compressed air line 120 is in communication with a vent port 122, which is in communication indirectly or directly with the atmosphere.

In a second switched position, referred to hereinafter as pressure supplying position or driving position, bistable valve 116 places a pressure present at its inlet 124 via compressed air line 118 in communication with outlet 126 or compressed air line 120, without changing this pressure. This second switched position is occupied in malfunction free driving operation of the brake system. In malfunction free parked condition of the vehicle, however, the first switched position is selected, and so compressed air line 120 is vented.

The positions of bistable valve 116 are switched via an electric control unit 128 of parking brake control module 32. For this purpose, electric control unit 128 is electrically connected via electric lines 130 to bistable valve 116. As an example, if parking brake signal transducer 82 is actuated, electric control unit 128 switches bistable valve 116 to its parked position by delivering a corresponding electric signal. In corresponding manner, however, electric control unit 128 can also switch bistable valve 116 to its driving position.

Via compressed air line 120, outlet 126 of bistable valve 116 is in communication with holding valve 132. Holding valve 132 is designed as an electromagnetic valve, which, in turn, is connected via electric lines 134 to electric control unit 128. Holding valve 132 can be electromagnetically actuated via electric control unit 128. Holding valve 132 is designed as a 2/2 way valve. In its switched position illustrated in FIG. 2, it allows compressed air to flow from compressed air line 120, which is in communication with an inlet 136 of holding valve 132, through to an outlet 138 of the holding valve, which outlet is in communication via a further compressed air line 140 with a control input 142 of relay valve 114.

In the second switched position, not illustrated in FIG. 2, holding valve 132 blocks the compressed air flow. To achieve metered flow of compressed air, valve 132 can be activated by electric control unit 128, for example by a clocked signal via electric lines 134. In this way, control input 142 of relay valve 114 can be pressurized with a predetermined pressure.

Holding valve 132 can also be designed as a proportional valve, in which case proportional or at least quasi proportional passage cross-sections can be adjusted between the extreme values of the passing position and the blocking position by activating the solenoids of the valve with suitable electric signals, such as clocked signals.

At its outlet 144, relay valve 114 delivers to a compressed air line 146 an output pressure that corresponds to the pressure injected via compressed air line 140 at control input 142 of relay valve 114 and, thus, into a control chamber of relay valve 114, in which case relay valve 114 draws the compressed air needed for this purpose from compressed air line 112, which is in communication with an inlet 148 of relay valve 114. Any venting of compressed air line 146 that may be necessary takes place via a vent outlet 149 of relay valve 114 indirectly or directly in communication with the atmosphere.

On the output side of relay valve 114, there is optionally disposed on compressed air line 146 a pressure sensor 150 which delivers an electric signal corresponding to the pressure in compressed air line 146 to electric control device 128 where it is evaluated as the actual pressure value.

Compressed air line 146 is in communication with compressed air line 80 leading to brake cylinders 24, 26.

Compressed air line 146 is also in communication with what is known as a trailer checking valve 152, which is preferably designed as a 3/2 way valve. A trailer checking function can be activated by means of this valve. The trailer checking function is a condition of brake system 10 in which the brakes of a trailer connected to the tractor are released while the parking brake function itself is active, in order to give the operator of the tractor an opportunity to check whether the braking action of the parking brake of the tractor is sufficient alone to prevent the entire vehicle train from rolling away if the vehicle train is parked. Such a check is necessary in particular for trailers whose trailer brakes could be released, for example due to gradual pressure loss, if the vehicle is parked for a prolonged time. In this case, it is desirable to ensure that the vehicle train will not roll away, and, accordingly, this must be effected by the parking brake of the tractor.

For actuation, trailer checking valve 152 is connected via electric line 154 to electric control unit 128. In a first switched position illustrated in FIG. 2, trailer checking valve 152 places pressure line 106 leading to trailer control valve 100 in communication with compressed air line 146. In its second switched position, trailer checking valve 152 places compressed air line 106 in communication with compressed air supply line 112 or compressed air line 92 and, thus, with the compressed air reservoir of third compressed air reservoir tank 90. In this second switched position, the trailer checking function is activated. For this purpose, reservoir pressure is admitted to the pressure control input of trailer control valve 100 in communication with compressed air line 106, thus bringing about release of the trailer brakes by means of an inverting function of trailer control valve 100.

In conventional systems, a check valve is disposed in compressed air line 92, or, in other words, outside parking brake module 32. In the case of breakaway of the trailer or of a leak in the parking brake circuit, this placement of the check valve prevents the spring store parts of spring brake cylinders 24, 26 from being vented. Such venting would lead specifically to application of the parking brake and to dangerous emergency braking of the tractor vehicle in the case of trailer breakaway.

In the exemplary embodiment of parking brake control module 32 illustrated in FIG. 2, check valve 156 is disposed in compressed air supply line 112, or, in other words, between the port of compressed air line 92 on parking brake module 32 and inlet 148 of relay valve 114. Relay valve 114 is blocking when the pressure at inlet 148 of relay valve 114 is higher than the pressure in pressure line 92. In the inverse case, or, in other words, when the pressure in pressure line 92 is higher than at inlet 148 of relay valve 114, check valve 156 opens, so that pressure or compressed air can pass without hindrance in this direction.

The relay valve is further arranged in such a way that the branch in compressed air supply line 112 to compressed air line 118 to bistable valve 116 is disposed upstream from check valve 156, or, in other words, between check valve 156 and the port of compressed air line 92 on parking brake module 32. By this arrangement of check valve 156, and in the event of an unexpected failure of the electric power supply, the control pressure present at control input 142 of relay valve 114 can be placed in communication with third compressed air reservoir tank 90 via holding valve 132, bistable valve 116 disposed in driving position, compressed air lines 140, 120 and 118 and compressed air line 92. By repeated actuation of the service brake in the case of a failed electric power supply, the pressure in first and second reservoir tanks 56, 58, and, thus, also in third reservoir tank 90, drops at first, since these are in communication with one another. However, because valves 116 and 132 are in passing position, and, thus, compressed air lines 92, 118, 120 and 140 are in communication with one another, a pressure drop in third reservoir tank 90 leads to a pressure drop in the control chamber of relay valve 114. This leads, in turn, to a pressure drop in pressure line 146, and, thus, also in compressed air line 80, and consequently to venting of the spring store parts of the spring brake cylinders. Thus, the spring actuators are activated, and, so, the parking brake is applied.

If the electric power supply fails, the vehicle engine dies. As a result, a compressor generating the compressed air cannot continue to deliver compressed air to the compressed air reservoir tank. This means that the remaining number of braking operations possible with the service brake is limited. Furthermore, the electro-pneumatic parking brake also fails because of the failure of the electric power supply. By virtue of the invention, however, the vehicle can still be parked. For this purpose the operator merely has to actuate brake pedal 62 several times. Because of the associated pressure drop in the service brake circuits and the parking brake circuit, the spring actuators of the spring brake cylinders can be slowly applied, so that the vehicle can be parked in controlled manner.

Advantageously, an additional pressure sensor 158 is also connected to compressed air line 112, specifically between check valve 156 and the port of compressed air line 92 on parking brake control module 32. This pressure sensor generates an electrical signal that corresponds to the pressure in compressed air supply line 112 upstream from check valve 156 and that is delivered via an electric line 160 to electric control unit 128. If the measured pressure during normal operation drops below a critical pressure, holding valve 132 is energized or switched such that the control pressure in the control chamber of relay valve 114 is confined. As a result, unintended application of the spring actuated brakes during normal operation can be prevented. An example of an unexpected pressure drop measured by pressure sensor 158 is use of the antilock brake system, which leads to a pressure drop in the brake circuits.

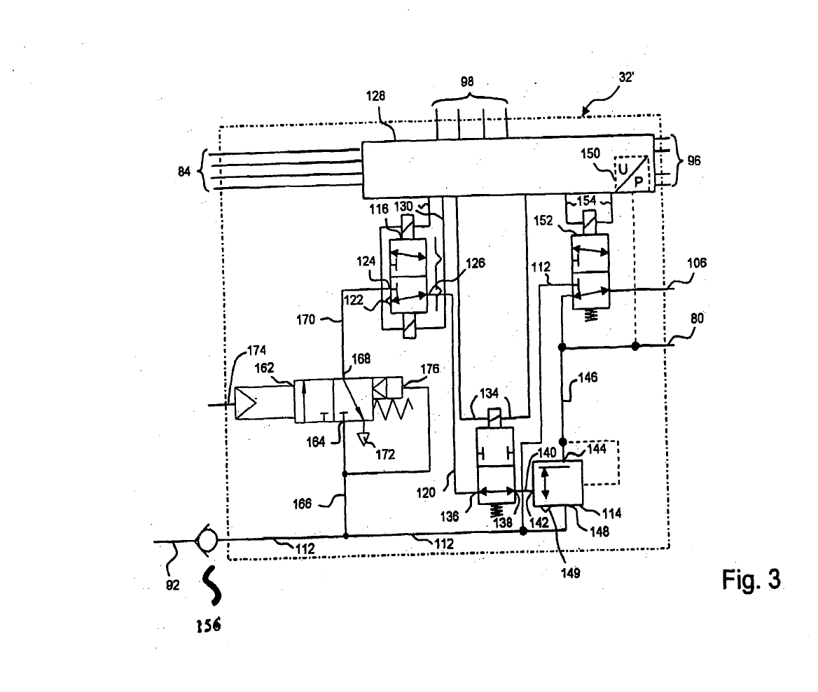

FIG. 3 shows a further embodiment of a parking brake control module 32′ in accordance with the present invention. Many components correspond to the components shown in FIG. 2 (like reference numerals being used for like components). To this extent, reference is made to the foregoing discussion in order to avoid repetition.

As a first difference between the exemplary embodiment according to FIG. 3 and the exemplary embodiment shown in FIG. 2, check valve 156 shown in FIG. 2 is installed not in parking brake control module 32′ but, instead, at the conventional position, namely, in compressed air line 92, which leads to brake control module 32′. A further difference is that bistable valve 116 with its inlet 124 is in communication with compressed air supply line 112 not directly, but, instead, via interposed valve device 162. This valve device 162 has an inlet 164 which is in communication with compressed air supply line 112 via a compressed air line 166. Valve device 162 also has an outlet 168 which is in communication via a compressed air line 170 with inlet 124 of bistable valve 116. Furthermore, valve device 162 has a vent outlet 172 that is indirectly or directly in communication with the atmosphere.

Valve device 162 also has a first input 174, which is in communication via a compressed air line with the reservoir pressure of the service brake, or, in other words, with the first and/or second compressed air reservoir tank 56, 58 in particular. The valve device also has a second input 176, which is in communication with compressed air line 166. Furthermore, valve device 162 is acted on by means of a spring force, and, so, valve device 162 occupies a predetermined or definite condition or a predetermined or definite switched position in the event of absence of pressures at inputs 174, 176. In normal operation a first switched position (not illustrated in FIG. 3) is provided in which inlet 164 of valve device 162 is in communication with its outlet 168. In this switched position, the reservoir pressure of the parking brake can be relayed via bistable valve 116, which is in driving position, and via open holding valve 132 to control input 142 of relay valve 114, so that a correspondingly high pressure is present at the outlet of relay valve 144. This pressure opens the spring actuated brakes or the parking brake, so that the vehicle can be driven without being braked.

If the electric power supply of the vehicle fails, however, it must be possible to bring the vehicle safely into a parked position with the parking brake applied. In a manner similar to that of the exemplary embodiment according to FIG. 2, the operator can now consume, and, thus, lower, the reservoir pressure in first and/or second compressed air reservoir tanks 56, 58 of the service brake by actuating brake pedal 62. As a result, the pressure at input 174 of valve device 162 also drops, and, so, valve device 162 is switched to the switched position shown in FIG. 3 when the pressure at input 174 has dropped by a definite pressure value below the pressure present at input 176. In this switched position, outlet 168 of valve device 162 is in communication with vent outlet 172, and, so, the compressed air present in compressed air line 170, and, thus, the compressed air present in compressed air line 120 and compressed air line 140, is vented, and so also is the control chamber of relay valve 114. This leads to a pressure drop at outlet 144 of relay valve 114 and, thus, also to venting of the spring store parts of the spring brake cylinders, so that the brake cylinders are vented when the threshold pressure at input 174 of valve device 162 is reached. Therefore, even in the event of failure of the electric power supply, the vehicle can still be parked safely. To achieve the full parking brake force, the pressure in the service brake circuits, especially in compressed air reservoir tanks 56, 58, must be lowered only to the aforesaid threshold pressure.

In the exemplary embodiment illustrated in FIG. 3, the service brake reservoir pressure is compared with the reservoir pressure of the parking brake at inputs 174 and 176, and, if the service brake pressure drops below a specified value, compressed air line 170 to bistable valve 116 is vented, so that the spring actuators are vented when bistable valve is in its driving position. In a further exemplary embodiment, not illustrated, it is sufficient, however, that only one pressure, namely that of the service brake reservoir tank, be supplied to the valve device. In contrast, it is not absolutely necessary for the reservoir pressure of the parking brake circuit to be supplied to input 176, although it is advantageous. Instead, it is possible to generate, in valve device 162, a back pressure opposing the pressure present at input 174 merely via a preloaded spring, so that valve device 162 is switched into the position illustrated in FIG. 3 if the pressure at input 174 drops below a specified threshold value. In this case, it is also possible, by repeated actuation of brake pedal 62, to lower the reservoir pressure in the service brake reservoir tanks to a threshold value at which the spring actuators are then suddenly vented. Thus, such embodiment also ensures that the vehicle can still be safely parked even if the electric power supply of the vehicle fails (and, as a result the electromagnetic parking brake also fails, the vehicle engine dies and the remaining number of braking operations with the service brake becomes limited).

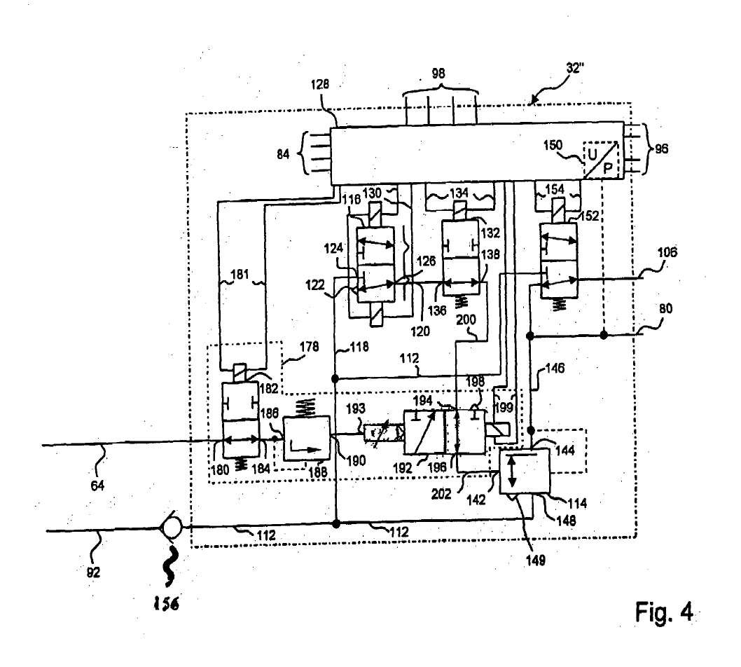

FIG. 4 shows a further exemplary embodiment of a parking brake control module 32″ in accordance with the present invention. The exemplary embodiment of parking brake control module 32″ shown in FIG. 4 corresponds in many components to the exemplary embodiment shown in FIGS. 2 and 3. To this extent, reference is made to the corresponding embodiments in order to avoid repetition. However, a difference exists in that check valve 156, located inside parking brake control module 32 in the embodiment illustrated in FIG. 2, is now located outside of parking brake control module 32″, upstream from the port of air pressure line 92 on parking brake control module 32″.

A further difference is seen in valve arrangement 178, which is connected upstream from control input 142 of relay valve 114 and is disposed between outlet 138 of holding valve 132 and control input 142 of relay valve 114. At input 180 of this valve arrangement 178, a redundancy pressure delivered by brake valve 60 via compressed air line 64 is admitted. A first component of valve arrangement 178 is a solenoid valve 182, which can be electrically actuated by control unit 128 via electric lines 181, and whose inlet forms input 160 of the valve arrangement. In normal operation, this solenoid valve is energized, and so it is brought into a switched position, not illustrated in FIG. 4, in which inlet 180 of solenoid valve 132 is not in communication with an outlet 184 of the solenoid valve, but instead is shut off. In a deenergized condition, however, solenoid valve 182 is open, and so its inlet 180 and its outlet 184 are in communication with one another.

The outlet of solenoid valve 184 is in communication with an inlet 186 of an overflow valve 188. This overflow valve 188 is designed in such a way that it becomes open from its inlet 168 to its outlet 190 when a pressure higher than a predetermined threshold pressure is present at inlet 168. As an example, this threshold pressure can amount to 80 to 90% of the pressure generated as the redundancy pressure during full braking or full actuation of the brake pedal.

In turn, outlet 190 of overflow valve 188 is in communication with a control input 193 of a further valve 192. This further valve 192 has an inlet 194, which is in communication with outlet 138 of holding valve 132, as well as an outlet 196, which is in communication with control input 142 of relay valve 114. Furthermore, this valve has a vent outlet 198 that is indirectly or directly in communication with the atmosphere. Valve 192 can be electromagnetically switched and is therefore connected via electric lines 199 to electric control unit 128. In the energized condition, which exists in normal operation, valve 192 is in the switched position shown in FIG. 4. If, in the case of failure of the electric power supply, a pressure is present for a predetermined time at input 193 of valve 192, valve 192 changes its switched position. In the process, outlet 196 of valve 192 is placed in communication with vent outlet 198, and, so, thereby, control input 142 of relay valve 114 is also vented. This leads to venting of the spring actuators and, thus, to application of the parking brake.

In contrast, in the switched position shown in FIG. 4, inlet 194 is in communication with outlet 196 of valve 192, and so the pressure present at control input 142 of relay valve 114 during normal driving operation can be supplied by pressure supply line 112 via compressed air line 118, bistable valve 116, compressed air line 120, holding valve 132, a further compressed air line 200, valve 192 and a further compressed air line 202.

By means of valve arrangement 178 described in connection with FIG. 4, even in the case of failure of the electric power supply of the vehicle, the parking brake can be applied by prolonged full actuation of brake pedal 62. For this purpose, the redundancy pressure is placed directly in communication with the parking brake control module. In normal operation, the redundancy pressure is then retained by solenoid valve 182. In the case of failure of the electric power supply, however, the redundancy pressure is switched through to a pneumatic logic unit (overflow valve 188 and valve 192). In the malfunction situation, this logic unit vents the control chamber of relay valve 114, and, thus, the spring actuators, if the redundancy pressure exceeds a predetermined pressure value for a predetermined time. In this way, the vehicle can be safely parked by prolonged full actuation of the service brake pedal even in the event of failure of the electric power supply and the associated failure of the electro-pneumatic parking brake.

The present invention enables final venting of the spring actuators of the parking brake in the event of power supply failure by actuation of the service brake pedal, so that the parking brake is finally applied. In all described exemplary embodiments, therefore, a parked condition of the parking brake and of the vehicle can be established, so that the operator can safely exit the vehicle.

It will thus be seen that the objects set forth above, among those made apparent from the preceding description, are efficiently attained, and since certain changes may be made in the above constructions without departing from the spirit and scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

1. In a vehicle brake system having a service brake and a parking brake, said service brake including a brake pedal and at least one spring actuated brake cylinder including a spring actuator part for actuating said parking brake, the improvement comprising an electro-pneumatic brake control device constructed and arranged to permanently vent said spring actuator part of said at least one spring actuated brake cylinder in response to said brake pedal when supply of electric power in said vehicle brake system fails.

2. An electro-pneumatic brake control device for a vehicle brake system, comprising:
a) a first compressed air line for supplying compressed air from a source of compressed air to actuate a spring actuator part of a spring actuated brake cylinder of a vehicle brake system;
b) an air flow boosting device having an inlet constructed and arranged for communication with said first compressed air line, and a first outlet constructed and arranged for communication with a second compressed air line to said spring actuator part of said spring actuated brake cylinder, said air flow boosting device further including a first pneumatic control input for supplying control pressure for controlling pressure at said first outlet;
c) an electrically actuated bistable valve having a second inlet constructed and arranged for communication with said first compressed air line, and a second outlet constructed and arranged for communication with said first pneumatic control input said second outlet in communication with a first vent when said bistable valve is in parked position and said second outlet in communication with said second inlet when said bistable valve is in driving position; and
d) an electric control unit electrically connected to which said bistable valve for controlling said bistable valve.

3. The brake control device according to claim 2, further comprising a holding valve in communication with said electric control unit and disposed between said first pneumatic control input and said second outlet said holding valve having a third inlet and a third outlet, said third inlet in communication with said third outlet when said holding valve is deenergized, and said third inlet shut off from said third outlet when said holding valve is energized.

4. The brake control device according to claim 2, further comprising a check valve disposed in said first compressed air line between said first inlet and a branch in said first compressed air line to said bistable valve, said check valve permitting unidirectional air flow to said air flow boosting device, and said branch being constructed and arranged for placement in communication with said source of compressed air without interposition of a further check valve.

5. The brake control device according to claim 4, further comprising a pressure sensor connected to said electric control unit and disposed in said first compressed air line at a position upstream from said check valve.

6. The brake control device according to claim 5, wherein said holding valve is energized when pressure in said first compressed air line falls below a preselected threshold value.

7. The brake control device according to claim 2, further comprising a valve device disposed between said second inlet and said first compressed air line, said valve device having a second input, a fourth inlet, a fourth outlet and a second vent, said second input in communication with reservoir pressure of a service brake of said vehicle brake system, said fourth inlet in communication with said first compressed air line, said fourth outlet in communication with said second inlet, said valve device having at least one of a first position and a second position, said first position being established when said reservoir pressure of said service brake is higher than a preselected threshold value and said fourth inlet is in communication with said fourth outlet, and said second position being established when said reservoir pressure of said service brake is lower than said preselected threshold value and said fourth outlet is in communication with said second vent.

8. The brake control device according to claim 7, wherein said valve device further includes a third input for pressure in said first compressed air line, and wherein said preselected threshold value represents pressure in said first compressed air line plus pressure exerted by a spring element.

9. The brake control device according to claim 2, further comprising a valve group disposed upstream from said first pneumatic control input, said valve group being constructed and arranged to be pressurized on an input side thereof with redundancy pressure of a redundant pneumatic brake circuit, said valve group being inactive in normal operation with said first compressed air line open to said air flow boosting device from at least one of (i) said bistable valve and (ii) a holding valve disposed between said first pneumatic control input and said second outlet, and said valve group being active to permanently vent said first pneumatic control input when supply of electric power to said vehicle brake system fails.

10. The brake control device according to claim 9, wherein said valve group vents said first pneumatic control input when said redundancy pressure exceeds a preselected threshold pressure for a preselected time period.

11. The brake control device according to claim 9, wherein said valve group includes a first solenoid valve having a fifth inlet in communication with a fifth outlet thereof when said solenoid valve is in a deenergized state, said fifth inlet being shut off from said fifth outlet when said solenoid valve is in an energized state.

12. The brake control device according to claim 9, wherein said valve group includes an overflow valve which opens when a preselected threshold pressure is exceeded.

13. The brake control device according to claim 9, wherein said valve group includes (i) a second solenoid valve disposed upstream from said first pneumatic control input and (ii) a timer constructed and arranged to switch said second solenoid valve from a first condition in which said first pneumatic control input is in communication with at least one of said electrically actuated bistable valve and said holding valve, to a second condition in which said first pneumatic control input is in communication with a third vent.

14. An electrically controlled pneumatic vehicle brake system, comprising a service brake and parking brake, said service brake including a brake pedal and compressed air actuated brake cylinders in communication with said brake pedal for actuation of wheel brakes, at least one of said brake cylinders being a spring actuated brake cylinder having a spring actuator part for actuating said parking brake, said parking brake including a parking brake signal transducer for actuating said parking brake by venting said spring actuator part, said vehicle brake system further comprising an electropneumatic brake control device constructed and arranged to permanently vent said spring actuator part in response to said brake pedal when supply of electric power in said vehicle brake system fails.

15. A vehicle, comprising an electrically controlled pneumatic brake system, said brake system including a service brake and parking brake, said service brake including a brake pedal and compressed air actuated brake cylinders in communication with said brake pedal for actuation of wheel brakes, at least one of said brake cylinders being a spring actuated brake cylinder having a spring actuator part for actuating said parking brake, said brake system further including an electropneumatic brake control device constructed and arranged to permanently vent said spring actuator part in response to said brake pedal when supply of electric power in said vehicle brake system fails.
